(19) United States
(12) Patent Application Publication
(10) Pub. No.: US 2012/0328917 A1
(43) Pub. Date: Dec. 27, 2012

(54) SECONDARY BATTERY AND METHOD FOR PRODUCING SAME

(76) Inventors: Kazuya Sakashita, Osaka (JP); Kazuo Yamada, Osaka (JP); Yoshihiro Tsukuda, Osaka (JP); Yuki Watanabe, Osaka (JP)

(21) Appl. No.: 13/530,523

(22) Filed: Jun. 22, 2012

(30) Foreign Application Priority Data
Jun. 24, 2011 (JP) 2011-140424

(51) Int. Cl. H01M 2/12; H01M 10/04; H01M 2/36

(52) U.S. Cl. 429/82; 29/623.2

(57) ABSTRACT

In order to obtain a secondary battery and a method for producing same whereby, notwithstanding the large size of an electrode group of several tens of stacked layers of positive electrode plates, negative electrode plates, and separators, any residual air, gases, or the like present between layers can be effectively driven out, and the electrolyte can be induced to reliably penetrate into the interior of the electrode group, secondary batteries RB1 to RB4 and the method for producing same are configured such that, during creation of a vacuum in a vacuum injection step, a predetermined section of a battery can 10 opposing the vicinity of the center part of an electrode group 1 undergoes deformation by a predetermined amount or more, and a venting function of driving out residual air between the layers is exhibited.

This application is based on Japanese Patent Application No. 2011-140424 filed on Jun. 24, 2011, the contents of which are hereby incorporated by reference.

### BACKGROUND OF THE INVENTION

1. Field of the Invention

The present invention relates to a secondary battery, and in particular relates to a secondary battery having a stacked electrode group, wherein the secondary battery is capable of effectively driving out residual air between layers, despite the secondary battery being provided with an electrode group of large planar size; and to a method for producing same.

2. Description of Related Art

In recent years, lithium secondary batteries, which have high energy density and are capable of being made small in size and light in weight, have come to be employed as power supply batteries in mobile telephones, notebook computers, and other such mobile electronic devices. Because high capacity is possible, they have also attracted interest as motor-driving power supplies in electric vehicles (EV), hybrid electric vehicles (HEV), and the like, as well as a storage battery for power storage.

The above lithium secondary batteries are configured so as to be provided with an electrode group composed of positive electrode plates and negative electrode plates disposed in opposition to either side of separators, and housed in the interior of an outer case constituting the battery can, which is filled with an electrolyte; a positive collector terminal coupled to positive collector tabs of the plurality of positive electrode plates; a positive external terminal electrically connected to this positive collecting terminal; a negative collector terminal coupled to negative collector tabs of the plurality of negative electrode plates; and a negative external terminal electrically connected to this negative collecting terminal.

Wound types and stacked types are known types of electrode groups. A wound electrode group has a configuration in which the positive electrode plates and the negative electrode plates, with separators interposed between them, are wound into an integrated unit. A stacked electrode group has a configuration in which the positive electrode plates and the negative electrode plates are stacked in a plurality of layers, via separators.

In a lithium secondary battery provided with a stacked electrode group, the configuration is one in which an electrode group of positive electrode plates and negative electrode plates stacked in a plurality of layers interposed by separators is housed within the outer case, which is then filled with a nonaqueous electrolyte. A positive collector terminal coupled to the positive collector tabs of the respective positive electrode plates, an external terminal electrically connected to this positive collector terminal, a negative collector terminal coupled to the negative collector tabs of the negative electrode plates, and an external terminal electrically connected to this negative collector terminal, are then respectively furnished.

In the case of this stacked type, in order to fabricate a secondary battery of high capacity, it is necessary to enlarge the surface area of the positive electrode plates and the negative electrode plates, and to increase the number of stacked layers, as well as to increase the amount of the electrolyte filling the battery. For this reason, it is crucial to induce the electrolyte to reliably penetrate into the interior of the electrode group, which has been fabricated to a state of large planar size and considerable thickness.

In the past, a vacuum injection method, which involves injection of the electrolyte while the interior of the battery can is placed under a vacuum, has been adopted for the purpose of inducing penetration of the electrolyte into a wound electrode group or a stacked electrode group. With regard to increased capacity, there has been previously proposed a method of producing a secondary battery which, with the aim of improving battery product quality and improving productivity in the nonaqueous electrolyte injection step (which tends to decline in association with higher density of the active material, and with elevated tension of the positive electrode plate, the negative electrode plate, and the separator), is provided with a first step of placing the can interior under a vacuum; a second step of injecting a gas able to dissolve in the electrolyte; a third step of injecting the electrolyte; and a further fourth step of pressure reduction for a predetermined time (for example, see Patent Document 1: Japanese Laid-open Patent Application 2007-335181).

Additionally, there has been previously proposed a method of producing a lithium ion secondary battery, in which a pressure reduction pattern of reduced pressure-injected electrolyte is repeated a plurality of times, to bring about improved impregnation by the electrolyte (for example, see Patent Document 2: Japanese Laid-open Patent Application 10-50339).

In order to improve battery product quality, it is important for the electrolyte to penetrate to a sufficient extent into the interior of the electrode group. Particularly in a large-capacity stacked secondary battery provided with an electrode group of positive electrode plates, negative electrode plates, and separators stacked in numerous (e.g., several tens of) layers, in order to maintain consistent battery capacity and battery product quality, it is preferable to induce the electrolyte to reliably penetrate into the interior of the electrode group.

In a secondary battery having positive electrode plates, negative electrode plates, and an electrolyte, in order to increase the capacity and prolong the battery life, it is preferable to increase the surface area for electricity generation, and to increase the amount of electrolyte filling the battery, which tends to enlarge the surface area of the respective electrode plates and increase the number of stacked layers, as well as increasing the amount of electrolyte filling the battery. In so doing, the time required for the electrolyte to penetrate to the interior of the stacked electrode plates (the center part of the electrode group) is longer, and productivity in the electrolyte injection step is lower.

By injecting the electrolyte while the battery can interior is placed under a vacuum, it is possible to induce the electrolyte to penetrate into the interior of the electrode group. However, with electrode groups of larger size, problems such as difficulty in completely evacuating the air inside the electrode group so that residual air is generated; difficulty in venting gas generated inside the electrode group during the initial charging step; or an inability to bring about sufficient penetration of the electrolyte into the electrode group interior, may arise.

Despite the fact that battery product quality can be improved, because the method disclosed in Patent Document 1 entails injecting a gas that dissolves in the electrolyte, the steps are complicated, extra equipment is required, and electrolyte injection costs are higher.

Moreover, by relying merely on repetition of a pressure reduction pattern, as in the method disclosed in Patent Document 2, it is difficult to sufficiently expel residual air or gas from the interior of an electrode group fabricated to large planar size and considerable thickness, or to bring about reliable penetration of the electrolyte.

For this reason, there is a need for a battery structure whereby it is possible for residual air or gas present between layers to be effectively driven out, and whereby the electrolyte can be induced to reliably penetrate into the interior of an electrode group; and for a method for producing a battery of such description.

### SUMMARY OF THE INVENTION

With the foregoing in view, it is an object of the present invention to afford a secondary battery and a method for producing same whereby, notwithstanding the large size of the electrode group of several tens of stacked layers of positive electrode plates, negative electrode plates, and separators, residual air or gas present between layers can be effectively driven out, and the electrolyte can be induced to reliably penetrate into the interior of the electrode group.

In order to attain the aforedescribed object, the present invention resides in a secondary battery comprising: an electrode group of positive electrode plates and negative electrode plates stacked in a plurality of layers interposed by separators; an outer case for housing the electrode group; and a top plate for sealing the outer case; the interior of a battery can constituted by the outer case and the top plate being filled with an electrolyte; wherein a predetermined section of the battery can opposing the vicinity of the center part of the electrode group is deformed by a predetermined amount or more due to being subjected to internal pressure reduction or to external pressure application, and a venting function for driving out residual air between layers is exhibited.

According to this configuration, the battery can is subjected to internal pressure reduction or to external pressure application to induce deformation of a predetermined section of the battery can during electrolyte injection when the battery can is filled with electrolyte, and to compress the center part of the electrode group, so that air remaining in the interior can be driven out. For this reason, there can be obtained a secondary battery in which no air remains in the center part of the electrode group, and the electrolyte can be induced to reliably penetrate into the interior of the electrode group.

In the secondary battery of the present invention having the aforedescribed configuration, the predetermined section is the center part of the top plate; and the top plate is of a uniform thickness at which deformation is facilitated. According to this configuration, during electrolyte injection, the top plate deforms, with the center part thereof experiencing large deformation, to effectively compress the center part of the electrode group, and exhibit the action of driving out air from the center section, which is difficult to vent.

In the secondary battery of the present invention having the aforedescribed configuration, the top plate has a peripheral area of predetermined thickness at which can strength is exhibited, and a thinner, more readily deformable center area; and when the battery can is subjected to internal pressure reduction or to external pressure application, only the center area deforms, the peripheral area experiencing substantially no deformation. According to this configuration, while the strength of the battery can is maintained, the center part of the electrode group can be more effectively compressed, residual air can be effectively driven out from the center part of the electrode group, and the electrolyte can be induced to penetrate into the interior of the electrode group.

In the secondary battery of the present invention having the aforedescribed configuration, the peripheral area and the center area are linked interposed by a step. According to this configuration, despite the peripheral area of the top plate being situated further away from the electrode group to increase the filled electrolyte capacity, the center area can be furnished at a position in proximity to the electrode group, affording a battery structure whereby it is possible to effectively drive out residual air between layers, while maintaining the electrolyte capacity.

In the secondary battery of the present invention having the aforedescribed configuration, the top plate has a dual layer structure of an outside top plate of predetermined thickness at which can strength is exhibited, and a thinner, more readily deformable inside top plate; and when the battery can is subjected to internal pressure reduction or to external pressure application, only the inside top plate deforms, the outside top plate experiencing substantially no deformation. According to this configuration, while the exterior dimensions and the strength of the battery can are maintained, the center part of the electrode group can be more effectively compressed, residual air can be effectively driven out from the center part of the electrode group, and the electrolyte can be induced to penetrate into the interior of the electrode group.

In the secondary battery of the present invention having the aforedescribed configuration, the battery can has a bottom plate that, when the battery can is subjected to internal pressure reduction or to external pressure application, experiences deformation in a section in proximity to the center part of the electrode group; and that, in cooperation with the top plate, exhibits a function of driving out and venting residual air between layers. According to this configuration, both the top plate and the bottom plate experience deformation when the battery can is subjected to internal pressure reduction or to external pressure application (for example, when a vacuum is created), and residual air can be more effectively driven out from the center part of the electrode group.

The present invention further provides a production method for a secondary battery in which an electrode group obtained by positive electrode plates and negative electrode plates being stacked in a plurality of layers interposed by separators is housed in an outer case, a top plate is attached to an opening of the outer case, sealing is achieved, a battery can is made, and an electrolyte is injected into the interior of the sealed battery can via a vacuum injection step; wherein when a vacuum is created in the vacuum injection step, a predetermined section of the battery can opposing the vicinity of the center part of the electrode group is subjected to deformation by a predetermined amount or more, and a venting function for driving out residual air between layers is exhibited.

According to this configuration, when a vacuum is created, a predetermined section of the battery can is subjected to deformation, the center part of the electrode group is compressed, and air remaining in the interior can be driven out until none remains. The configuration is therefore one by which the electrolyte is injected after air in the interior of the electrode group has been sufficiently vented, affording a production method for a secondary battery whereby the electrolyte can be induced to reliably penetrate into the interior of the electrode group.

In the production method for a secondary battery of the present invention having the aforedescribed configuration, the predetermined section is a center area of the top plate, a center area of the bottom plate of the outer case, or both. According to this configuration, during vacuum injection, a center area of the top plate and/or a center area of the bottom plate experiences large deformation, effectively compressing the center part of the electrode group, and exhibiting an action of driving out air in the center part, which is difficult to vent.

In the production method for a secondary battery of the present invention having the aforedescribed configuration, the vacuum injection step is provided with an injection step in which a vacuum is created inside the battery can, a predetermined section of the battery can is subjected to deformation, and an electrolyte is injected; and a degassing step in which, after the electrolyte has been injected, a vacuum is created and the predetermined section subjected to deformation a second time to perform degassing of the electrode group interior. According to this configuration, there is provided an injection step in which a vacuum is created inside the battery can to drive out air inside the electrode group, followed by injection of the electrolyte, and a degassing step in which, subsequent to this injection step, the predetermined section of the battery can is subjected to deformation a second time to perform degassing of the electrode group interior, whereby air and gas in the electrode group interior can be effectively driven out, and the electrolyte can be induced to reliably penetrate into the interior of the electrode group

### BRIEF DESCRIPTION OF THE DRAWINGS

FIG. 1 is a sectional schematic view showing a first embodiment of the secondary battery according to the present invention;

FIG. 2 is a sectional schematic view showing a second embodiment of the secondary battery according to the present invention;

FIG. 3 is a sectional schematic view showing a third embodiment of the secondary battery according to the present invention;

FIG. 4A is a sectional schematic view showing a first mode of a fourth embodiment of the secondary battery according to the present invention;

FIG. 4B is a sectional schematic view showing a second mode of the secondary battery of the fourth embodiment;

FIG. 5 is a simplified schematic view showing a mode of penetration of an electrolyte in the interior of an electrode group;

FIG. 6 is a measurement diagram showing levels of deformation of an outer case according to the present invention;

FIG. 7 is a flowchart showing production steps of a secondary battery;

FIG. 8 is a table showing functional effects of the outer case according to the present invention;

FIG. 9 is an exploded perspective view of a secondary battery;

FIG. 10 is exploded perspective view of an electrode group provided to a secondary battery;

FIG. 11 is a perspective view of a completely assembled secondary battery; and

FIG. 12 is a simplified sectional view of an electrode group.

### DETAILED DESCRIPTION OF PREFERRED EMBODIMENTS

The embodiments of the present invention are described below with reference to the drawings. Equivalent constituent members have been assigned like reference numerals, and are not discussed in detail.

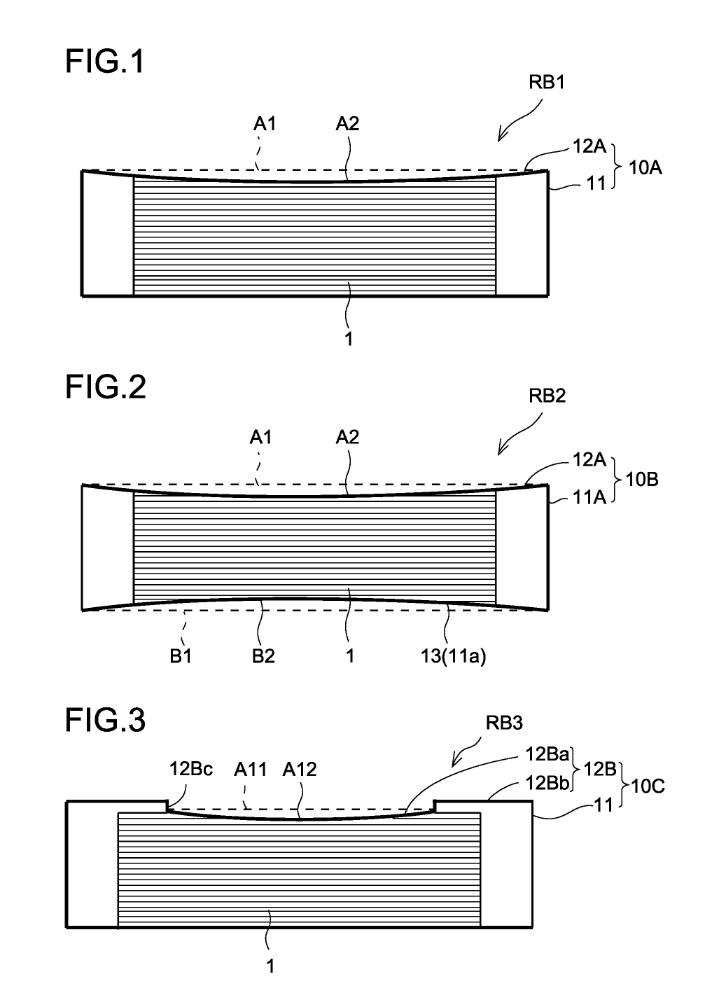

A lithium secondary battery will be described as the secondary battery according to the present invention. For example, the secondary battery RB1 according to the present invention shown in FIG. 1 is a lithium secondary battery of stacked type, in which a stacked electrode group 1 of positive electrode plates and negative electrode plates stacked in a plurality of layers interposed by separators is housed within a battery can 10A made of an outer case 11 and a top plate 12A, which is filled with an electrolyte. By enlarging the surface area of the electrode plates and increasing the number of stacked layers, it is possible for the secondary battery to have relatively large capacity appropriate for use as a storage battery for an electrical vehicle, a storage battery for power storage, or the like.

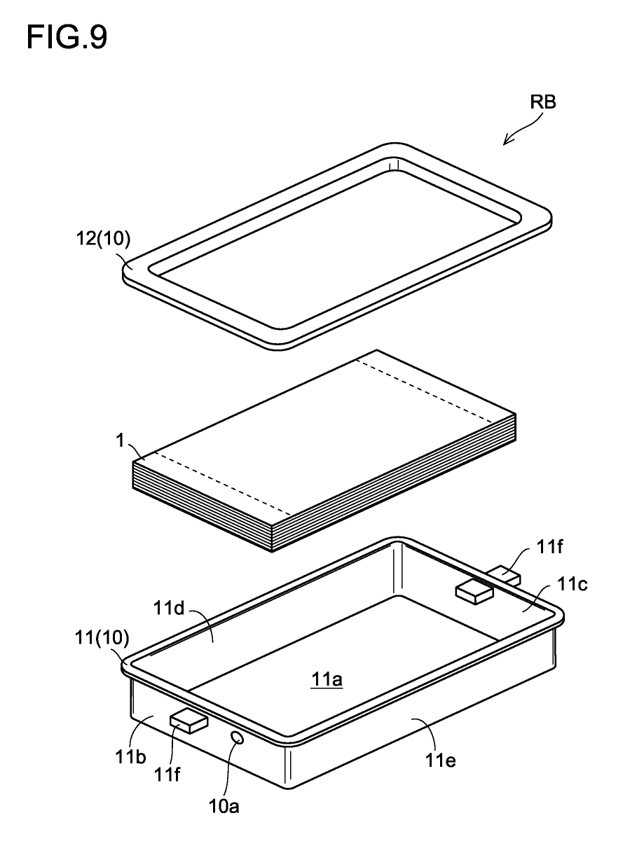

Next, the specific configuration of the stacked lithium secondary battery RB and the electrode group 1 are described with reference to FIGS. 9 to 12.

As shown in FIG. 9, the stacked lithium secondary battery RB is rectangle-shaped in plan view, and is provided with an electrode group 1 of stacked positive electrode plates, negative electrode plates, and separators, which are respectively rectangle-shaped, and housed in a battery can 10 constituted by the top plate 12, and the outer case 11 of box shape provided with a bottom part 11a and side parts 11b to 11e. Charge and discharge are performed from external terminals 11f furnished on side faces of the outer case 11 (for example, the two opposing side walls of the side parts 11b and 11c).

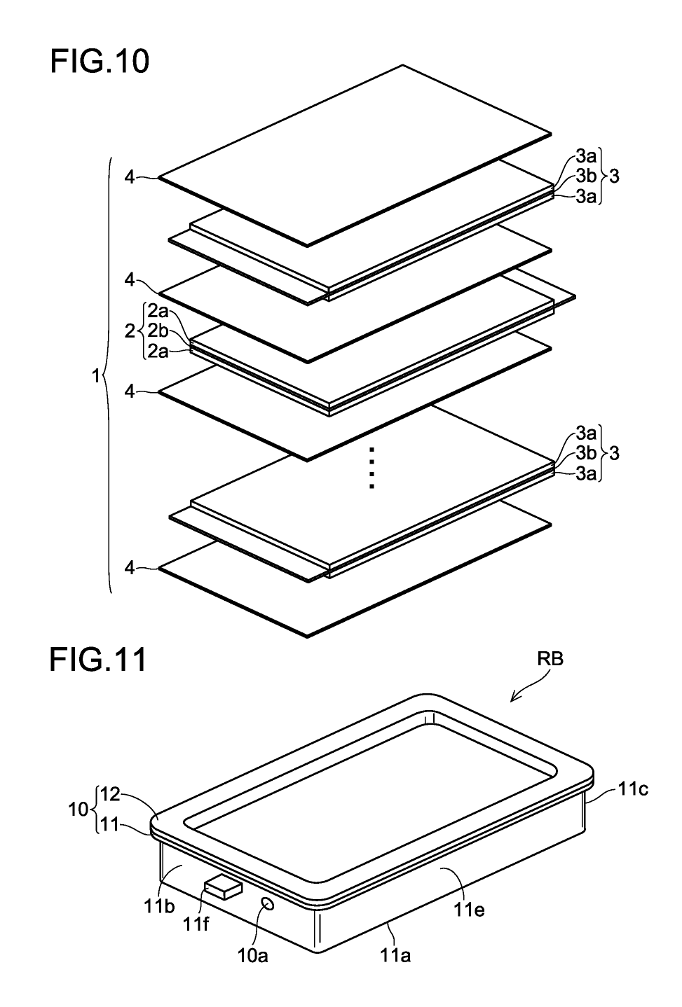

The electrode group 1 has a configuration in which the positive electrode plates and the negative electrode plate are stacked in a plurality of layers via the separators. As shown in FIG. 10, positive electrode plates 2 formed by positive electrode active substance layers 2a of a positive electrode active substance on both faces of a positive collector 2b (e.g. aluminum foil), and negative electrode plates 3 formed by negative electrode active substance layers 3a of a negative electrode active substance on both faces of a negative collector 3b (e.g. copper foil), are stacked via separators 4.

The separators 4 are intended to insulate the positive electrode plates 2 and the negative electrode plates 3, but allow lithium ions to move between the positive electrode plates 2 and the negative electrode plates 3 via the electrolyte filling the outer case 11.

As examples of the active substance of the positive electrode plates 2, there can be cited oxides containing lithium (such as LiCoO₂, LiNiO₂, LiFeO₂, LiMnO₂, LiMn₂O₄, etc.), as well as compounds in which some of the transition metal of the oxide has been substituted with other metal elements. When the positive electrode active substance is one such that, during normal usage, 80% or more of the lithium of the positive electrode plates can be utilized in the battery reaction, safety in relation to events such as overcharge can be enhanced.

As the negative electrode active substance of the negative electrode plate 3, there is employed a substance containing lithium, or a substance capable of intercalation and deintercalation of lithium. In particular, in order to impart high energy density, it is preferable to employ one having a lithium intercalation/deintercalation potential that approaches the precipitation/dissolution potential of metallic lithium. Typical examples are natural graphite or artificial graphite of granular form (scale form, lump form, fiber form, whisker form, spherical form, milled granular form, etc.)

Conductive materials, thickeners, binders, and the like may be contained in addition to the positive electrode active substance of the positive electrode plate 2, or in addition to the negative electrode active substance of the negative electrode plate 3. There is no particular limitation as to the conductive material, provided that it is an electron-conductive material and does not adversely affect the battery performance of the positive electrode plate 2 or the negative electrode plate 3. For example, carbon black, acetylene black, ketjen black, graphite (natural graphite or artificial graphite), carbon fibers, and other such carbon materials, or conductive metal oxides, can be employed.

As thickeners, there can be employed, for example, polyethylene glycols, cellulose, polyacrylamides, poly N-vinylamides, poly N-vinylpyrrolidones, and the like. Binders play the role of binding together the active substance particles and the conductive material particles; polyvinylidene fluoride, polyvinylpyridene, polytetrafluoroethylene, and other fluorine-based polymers; polyethylene, polypropylene, and other polyolefin based polymers; styrene-butadiene rubber, or the like can be used.

As the separators 4, it is preferable to employ a microporous polymer film. In specific terms, it is possible to use films of nylon, cellulose acetate, nitrocellulose, polysulfone, polyacrylonitrile, polyvinylidene fluoride, polypropylene, polyethylene, polybutene, or other polyolefin polymers.

As the electrolyte, it is preferable to employ an organic electrolyte. In specific terms, as the organic solvent of the organic electrolyte, it is possible to use ethylene carbonate, propylene carbonate, butylene carbonate, diethylene carbonate, dimethyl carbonate, methyl ethyl carbonate, γ-butyrolactone, or other esters; tetrahydrofuran, 2-methyl tetrahydrofuran, dioxane, dioxolane, diethyl ether, dimethoxyethane, diethyoxyethane, methoxyethoxy ethane, or other ethers; as well as dimethyl sulfoxide, sulfolane, methylsulfolane, acetonitrile, methyl formate, methyl acetate, and the like. These organic solvents may be used individually, or used in mixtures of two or more types.

The organic solvent may contain an electrolyte salt as well. As electrolyte salts, there may be cited lithium perchlorate (LiClO₄), lithium borofluoride, lithium hexafluorphosphate, trifluoromethanesulfonic acid (LiCF₃SO₃), lithium fluoride, lithium chloride, lithium bromide, lithium iodide, lithium tetrachloroaluminate, and other lithium salts. These electrolyte salts may be used individually, or used in mixtures of two or more types.

While the concentration of the electrolyte salt is not particularly limited, it is preferably about 0.5 to about 2.5 mol/L, more preferably about 1.0 to 2.2 mol/L. In cases in which the concentration of the electrolyte salt is less than 0.5 mol/L, the carrier concentration in the electrolyte tends to be low, and there is a risk of the electrolyte developing high resistance. On the other hand, in cases in which the concentration of the electrolyte salt is higher than about 2.5 mol/L, the salt itself tends to have a low degree of dissociation, and there is a risk that the carrier concentration in the electrolyte will not increase.

The battery can 10 is provided with the outer case 11 and the top plate 12, and is made of iron, nickel-plated iron, stainless steel, aluminum, or the like. As shown in FIG. 11, in the present embodiment, the battery can 10 is formed such that when the outer case 11 and the top plate 12 are combined, the exterior shape is substantially a flattened square shape.

The outer case 11 is box shaped having a bottom part 11a with a generally rectangular bottom face; and four side parts 11b to 11e that rise up from this bottom part 11a. The electrode group 1 is housed in the interior of the box. The electrode group 1 is provided with a positive collector terminal coupled to the collector tabs of the positive electrode plates, and a negative collector terminal coupled to the collector tabs of the negative electrode plates. External terminals 11f electrically connected to these collector tabs are respectively furnished to side parts of the outer case 11. The external terminals 11f are furnished, for example, at two locations on two opposing side parts 11b, 11c. 10a denotes an injection port, from which the electrolyte is injected.

Once the electrode group 1 has been housed in the outer case 11, and the respective collector terminals have been connected to the external terminals, or once the respective external terminals have been connected to the collector terminals, the electrode group 1 has been housed in the outer case 11, and the external terminals have been anchored to predetermined regions of the outer case, then the top plate 12 is secured to the rim of the opening of the outer case 11. Thereupon, the electrode group 1 becomes wedged between the bottom part 11a of the outer case 11 and the top plate 12, and the electrode group 1 is retained inside the battery can 10. The top plate 12 may be secured to the outer case 11, for example, by laser welding or the like. Connections between the collector terminals and the external terminals may be performed by ultrasonic welding, laser welding, resistance welding, or other welding techniques, or by using a conductive adhesive or the like. Connection methods other than these are acceptable as well, and a configuration whereby the outer case 11 and the top plate 12 are sealed by being seamed together at their edges is also acceptable.

As described above, the configuration of the stacked secondary battery according to the present embodiment is provided with the electrode group 1 of positive electrode plates 2 and negative electrode plates 3 stacked in a plurality of layers via the separators 4, the outer case 11 housing this electrode group 1 and filled with the electrolyte, the external terminals 11f furnished to the outer case 11, the positive and negative collector terminals electrically connected to the positive and negative electrode plates and to the external terminals 11f, and the top plate 12 installed onto the outer case 11.

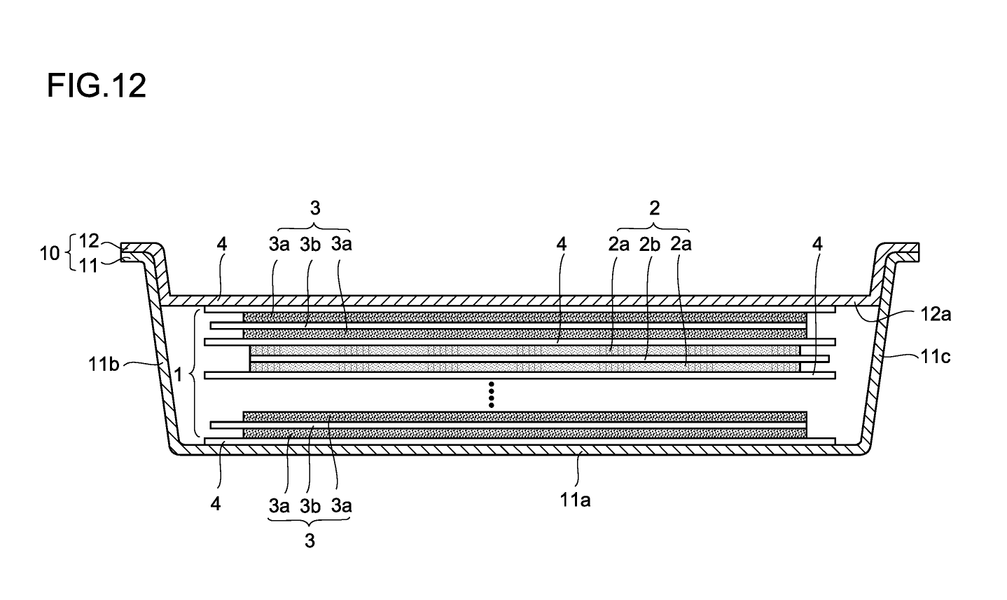

As shown in FIG. 12, for example, the electrode group 1 housed in the outer case 11 includes the positive electrode plates 2 in which the positive electrode active substance layers 2a have been formed on both sides of the positive collector 2b, and the negative electrode plates 3 in which the negative electrode active substance layers 3a have been formed on both sides of the negative collector 3b, these being stacked via the separators 4, and with separators 4 arranged on the two end faces as well. A configuration in which, in place of the separators 4 on the two end faces, the electrode group 1 is wrapped in a resin film of the same material as the separators 4 to cover it with a resin film having insulating properties is also acceptable. In either case, the configuration is one in which a member having electrolyte permeability and insulating properties is stacked on the top surface of the stacked electrode group 1. For this reason, the top plate 12 can be made to abut this surface, making it possible to press against it.

In order for a predetermined battery capacity to be exhibited, it is crucial that the electrolyte penetrate sufficiently into the interior of the electrode group 1, and therefore when the electrode group 1 is larger and thicker, the interior of the electrode group 1 needs to be vented sufficiently during production of the secondary battery, so that no air remains.

It is possible to expel air from the interior of the electrode group 1, for example, by creating a vacuum in the sealed battery can 10 once the electrode group 1 has been housed in the outer case 11, and the top plate 12 has been installed. However, when the electrode group 1 is larger in size, it may be difficult to completely expel air remaining in the interior of the electrode group 1, even when the degree of vacuum is raised, or the duration of the vacuum is extended.

According to the present embodiment, whereas the electrode group 1 is large and composed of several tens of stacked layers of positive electrode plates, negative electrode plates, and separators, nevertheless, by virtue of a configuration in which the battery can is subjected to internal pressure reduction or to external pressure application, thereby inducing deformation of a predetermined section of the battery can during venting of air or gas in the interior (for example, during creation of a vacuum and injection of the electrolyte, or during degassing), and compressing the center part of the electrode group 1 to exhibit a venting function for driving out residual air in the interior, there is afforded a secondary battery in which it is possible for air expelled with difficulty from the center part of the stack to be effectively driven out, for electrolyte permeation to be improved, and for bringing about reliable penetration of the electrolyte into the interior of the electrode group 1; as a well as a method for production thereof. Next, a specific embodiment of the secondary battery is described by FIGS. 1 to 4.

A secondary battery RB1 of a first embodiment shown in a sectional schematic view in FIG. 1 is provided with an electrode group 1 of positive electrode plates and negative electrode plates, which are stacked in a plurality of layers interposed by separators; an outer case 11 housing this electrode group; and a top plate 12A for sealing the outer case 11. The interior of the battery can 10A of the secondary battery RB1, which is composed of the outer case 11 and the top plate 12A, is filled with an electrolyte. When the electrolyte is injected, this battery can 10A is subjected to internal pressure reduction or to external pressure application, thereby inducing deformation, by a predetermined amount or more, of a predetermined section opposing the vicinity of the center part of the electrode group 1, and exhibits a venting function for driving out residual air between layers.

For example, in a configuration in which the top plate 12A is made of sheet metal of a thin, uniform thickness, by subjecting the battery can to internal pressure reduction or to external pressure application, the top plate 12A is deformed from the state shown by the broken line A1 to one shown by the solid line A2 in the drawing; and during this time, particularly the center section thereof experiences deformation (inward shifting) by a predetermined amount or more, compressing the electrode group 1. As shown in the drawing, the top plate 12A may be shaped like a flat plate; or shaped like a dish so that the section thereof that abuts the top surface of the electrode group 1 is projected to a protruding profile which fits into the outer case 11. The appropriate shape is selected for the size of the battery can 10A and the thickness of the electrode group 1. Any configuration adapted to induce inward shifting of the center section of the top plate 12A when the battery can is subjected to internal pressure reduction or to external pressure application is acceptable, and therefore the thickness of the plate may be such as to afford deformation by a predetermined amount or more in response to a degree of pressure reduction, or to bring about inward shifting by a predetermined amount or more by application of outside force to a plate of readily-deformable thickness. In either case, the present embodiment will be understood to include a configuration whereby the surface of the top plate 12A in opposition to the electrode group 1 deforms in a uniform manner, pressing against and compressing the center section of the electrode group 1.

According to the aforedescribed configuration, when, for example, a vacuum has been created, a predetermined section (for example, the center part of the top plate 12A) of the battery can 10A can be made to deform by a predetermined amount or more, to compress the center part of the electrode group 1 and effectively drive out air and/or gas remaining in the interior. Therefore, there can be obtained a secondary battery RB1 in which no air or gases remain in the center part of the electrode group 1, and in which the electrolyte reliably penetrates into the interior of the electrode group 1, for improved permeation during the injection step to reduce the pressure in the battery can 10A interior while injecting the electrolyte.

It is also acceptable for a bottom plate 13 to deform together with the top plate 12A, as in another secondary battery RB2 shown in FIG. 2. Like the previously shown bottom part 11a of the outer case 11, this bottom plate 13 may have thin plate thickness. Also, the outer case 11A may be provided with a bottom plate 13 furnished with a thin part in a portion thereof, making it readily deformable. Also acceptable is a configuration in which the plate thickness is readily deformable, and additionally, outside force is applied in order to increase the amount of deformation, to induce inward shifting by a predetermined amount or more.

Thus, e.g., when a vacuum is created, the secondary battery RB2, which has a battery can 10B made from the top plate 12A and the outer case 11A, which deforms in upper and lower portions in the vicinity of the center part of the electrode group 1, and which is provided with the bottom plate 13 that, in cooperation with the top plate 12A, exhibits a venting function to drive out residual air between layers, undergoes deformation (inward shifting) in the central part of the top plate 12A from the state shown by the broken line A1 to the state shown by the solid line A2 in the drawing, and undergoes deformation (inward shifting) in the central part of the bottom plate 13 from the state shown by the broken line B1 to the state shown by the solid line B2 in the drawing. Specifically, when a vacuum is created, both the top plate 12 and bottom plate 13 deform, compressing the center area of the electrode group 1 from above and below, to more effectively drive out residual air or gases in the center part of the electrode group.

The predetermined section of the battery can 10A that deforms when a vacuum is created is, for example, the top plate 12A arranged in opposition to the electrode group 1. This top plate 12A may be one of uniform, readily-deformable thickness; or the top plate may be one having a peripheral area of predetermined thickness at which can strength is exhibited, and a thinner central area of a more readily deformable thickness, such that when a vacuum is created, only the center area deforms, with the peripheral area experiencing substantially no deformation. With either configuration, when a vacuum is created, the top plate deforms, and the center part thereof experiences greater deformation, so that the center part of the electrode group 1 is more effectively compressed, and an action of driving out air and gases from the difficult-to-vent center section is exhibited.

Where the configuration is one provided with a peripheral area of predetermined thickness at which can strength is exhibited, the center part of the electrode group 1 can be more effectively compressed, while maintaining the strength of the battery can 10A. Further, where the configuration is one in which the peripheral area and the center area are linked interposed by a step, the peripheral area of the top plate can be further away from the electrode group, so that even if the electrolyte capacity is greater, the center area can be furnished at a location in proximity to the electrode group 1, affording a battery structure whereby it is possible to effectively drive out residual air, gases, and the like from between layers, while maintaining the battery capacity.

For example, as in a secondary battery RB3 of a third embodiment shown in FIG. 3, the battery can 10C may be provided with top plate 12B having a peripheral area 12Bb of predetermined thickness, and a thinner, more readily deformable center area 12Ba. A configuration provided with step 12Bc linking these and forming a large step is also acceptable.

Despite the thinner thickness of the center area 12Ba, the strength of the battery can 10C can be maintained via the peripheral area 12Bb of predetermined thickness adapted to exhibit strength. When a vacuum is created, the center area 12Ba readily deforms from the state shown by the broken line A11 to the state shown by the solid line A12 in the drawing, and compresses the center part of the electrode group 1 at a predetermined level of pressing force. During this time, the center area 12Ba deforms (shifts inward) in response to the degree of vacuum of the vacuum created inside the battery can 10C, and exhibits a venting function wherein the electrode group 1 is compressed and residual air, gases, and the like are driven out from between layers.

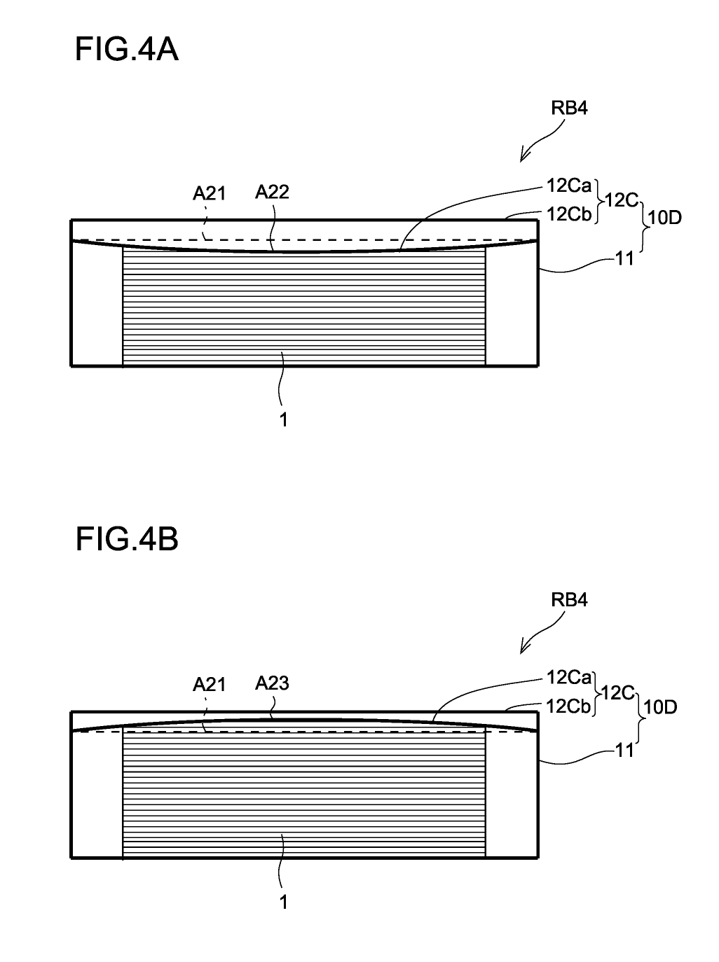

As in the sectional schematic view shown in FIG. 4A, a top plate 12C having a double structure (dual layer structure) provided with an outside top plate 12Cb and an inside top plate 12Ca may be employed. In this case, the outside top plate 12Cb is given predetermined thickness at which can strength is exhibited, while the inside top plate 12Ca is made thinner and readily deformable.

For this reason, when a vacuum is created in a secondary battery RB4 of a fourth embodiment provided with this top plate 12C, the outside top plate 12Cb experiences substantially no deformation, and only the inside top plate 12Ca deforms from the state shown by the broken line A21 to the state shown by the solid line A22 in the drawing, whereby, while the exterior dimensions and the strength of the battery can 10D are maintained, the center part of the electrode group 1 can be more effectively compressed; residual air, gases, and the like can be effectively driven out from the center part of the electrode group 1; and the electrolyte can be made to penetrate into the center part of the electrode group 1.

As shown in FIG. 4B, with such a configuration, even if the electrode group 1 should expand and cause the internal pressure to rise, only the inside top plate 12Ca deforms from the state shown by the broken line A21 to the state shown by the solid line A23 in the drawing, whereas the outside top plate 12Cb does not deform, and there is no change in the exterior dimensions of the battery can 10D. Specifically, in a secondary battery system configuration in which a plurality of stages of these battery cans 10D are disposed, the exterior dimensions do not change, and can be kept stable.

With the secondary batteries RB1, RB2, RB3, RB4 of the aforedescribed configurations, during electrolyte injection by subjecting the battery can to internal pressure reduction or to external pressure application, the center part of the electrode group 1 can be reliably compressed, and residual air, gases, and the like can be effectively expelled therefrom, improving permeation of the electrolyte. For this reason, notwithstanding the large size of the electrode group 1 of several tens of stacked layers of positive electrode plates 2, negative electrode plates 3, and separators 4, the electrolyte can be induced to reliably penetrate into the interior of the electrode group 1.

In a case in which the shape of the electrode group 1 is rectangular in plan view, the shape of the predetermined readily-deformable part may be either rectangular or circular (including elliptical) in plan view. With this configuration, when the battery can is subjected to internal pressure reduction or to external pressure application (for example, when a vacuum is created), the center section deforms (shifts inward) into a convex lens shape, pushing against and compressing the center section of the electrode group 1 which is rectangular in plan view, an action of driving out difficult-to-vent air, gases, and the like from the center section is exhibited, and the electrolyte can be induced to penetrate sufficiently into the center section of the electrode group 1.

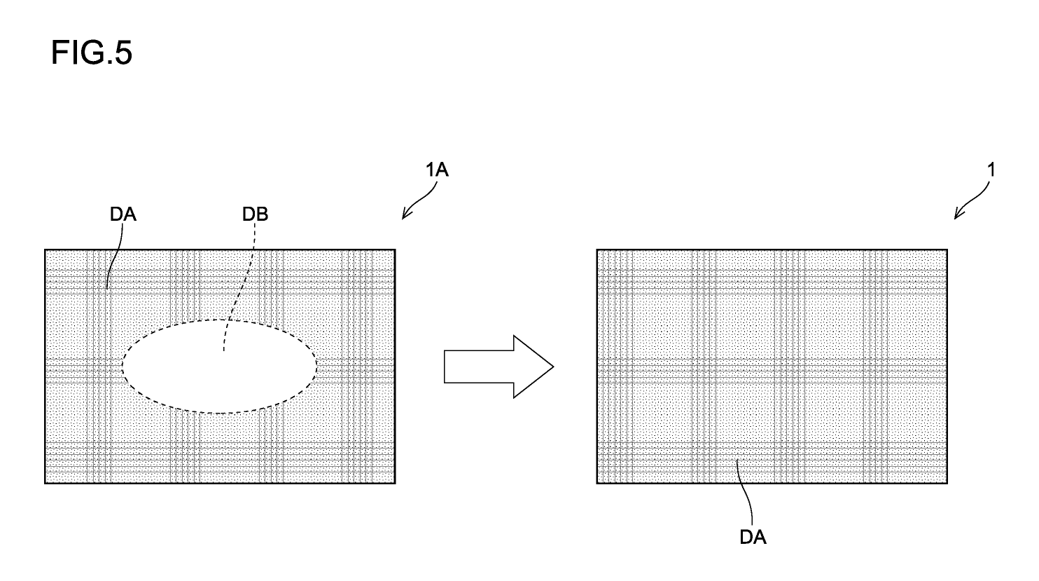

For this reason, as shown in schematic view in FIG. 5, in a case of a battery can configuration that is not one whereby, when a vacuum is created, the resultant deformation drives out residual air from the center part of the electrode group, a penetrated section DA that is penetrated by the electrolyte, and an unpenetrated section DB that is not penetrated by the electrolyte, are present in the interior of the electrode group 1A. However, with the secondary batteries RB1 to RB4, which are configured to deform and drive out residual air from the center part of the electrode group when a vacuum is created, no unpenetrated section DB unpenetrated by the electrolyte is present, and the penetrated section DA is uniformly penetrated by the electrolyte.

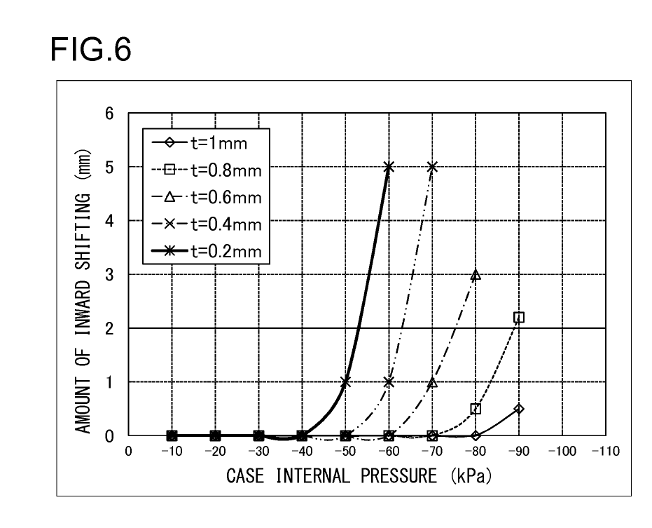

Next, the results of fabricating actual battery cans of various thicknesses, and measuring the amount of change when a vacuum is created, will be described with reference to FIG. 6.

The size of the battery cans employed for the measurements was 320 mm×150 mm×40 mm. Specifically, the battery cans were 320 mm×150 mm rectangles, 40 mm in thickness. Using 32 positive electrode plates 2, the size of these positive electrode plates being 140 mm×250 mm, and the thickness being 230 μm, 33 negative electrode plates 3, the size of these negative electrode plates being 142 mm×255 mm, and the thickness being 146 μm, and, as the separators, 64 polyethylene films 145 mm×255 mm in size and 25 μm in thickness, an electrode group was fabricated.

For the top plates 12, there were employed five different nickel-plated iron plates of 0.2 mm, 0.4 mm, 0.6 mm, 0.8 mm, and 1.0 mm thicknesses. For the outer case 11, a nickel-plated iron plate 1.0 mm thick was employed.

As will be understood from FIG. 6, at −70 kPa, an inward shift of 1 mm was observed at thickness t=0.6 mm, and an inward shift of 5 mm was observed at thickness t=0.4 mm. At thickness t=0.2 mm, an inward shift of 5 mm was observed −60 kPa; and at thickness t=0.8 mm, an inward shift of a mere 0.5 mm was observed at −80 kPa.

Specifically, for the secondary battery RB1 employing the battery can 10 with the top plate 12 thickness of 0.4 mm, when a −70 kPa vacuum was created, the top plate 12 deformed (shifted inward) by 5 mm, and the center part of the electrode group could be pushed and compressed by a corresponding extent.

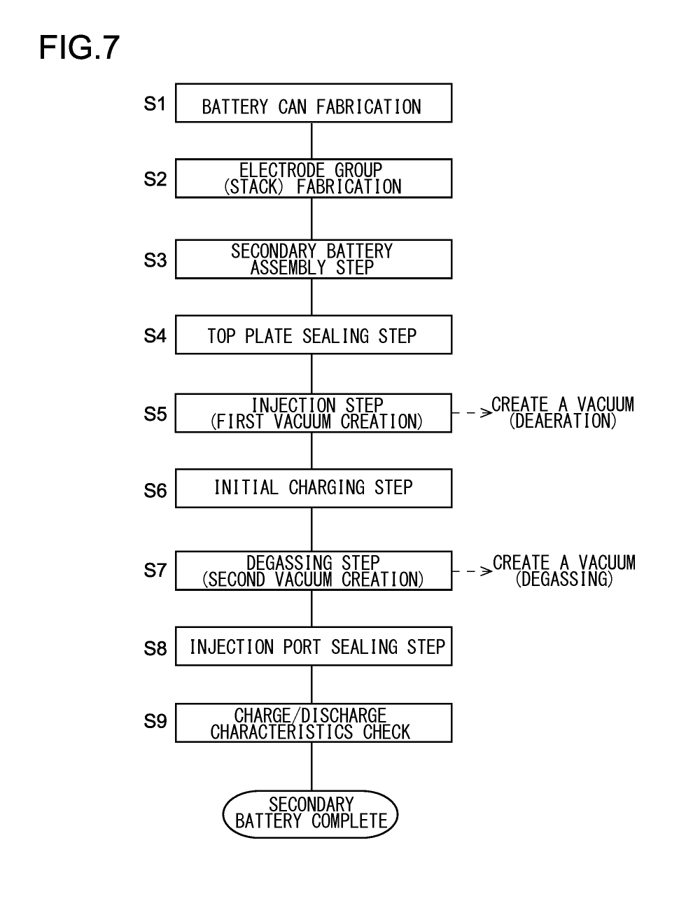

Next, a production method for this secondary battery will be described employing the flowchart shown in FIG. 7.

Firstly, a battery can of predetermined size is fabricated (S1), and a predetermined number of positive electrode plates, negative electrode plates, and separators of predetermined sizes are stacked sequentially to fabricate an electrode group (stack) (S2). Next, the collector terminals are connected, a secondary battery assembly step S3 is performed to connect the aggregate-connected collector terminals to the external terminals, and the top plate is attached and sealed (top plate sealing step S4).

After this, via the injection port, a vacuum is created for deaeration (first vacuum creation), the electrolyte is injected (electrolyte injection step S5), and initial charging is carried out (initial charging step S6). After this initial charging step S6, a degassing step S7 in which the gas generated thereby is removed (second vacuum creation) is performed. During this degassing step, the electrolyte may be injected to top up any shortfall. Then, after a step to seal the injection port (injection port sealing step S8), a step to perform charge/discharge and check the characteristics (charge/discharge characteristic check step S9) is carried out, to complete the secondary battery.

In the aforedescribed manner, in the production method for the secondary battery according to the present embodiment, an electrode group of positive electrode plates and negative electrode plates stacked in a plurality of layers interposed by separators is housed in an outer case; a top plate is attached and seals the opening of this outer case to constitute the battery can; and an electrolyte is injected into the interior of the sealed battery can via a vacuum injection step. When a vacuum is created in the sealed battery can, a predetermined section thereof in opposition to the vicinity of the center part of the electrode group deforms by a predetermined amount or more, and exhibits a venting function for driving out residual air between layers. Injection of the electrolyte takes place after air, gases, or the like between layers have been sufficiently vented.

Deformation (inward shifting), by a predetermined amount or more, of a predetermined section in opposition to the vicinity of the center part of the electrode group refers herein both to adopting a thinner profile for the predetermined section that is intended to shift inward, to bring about inward shifting thereof by a predetermined amount depending on the degree of vacuum; and to application of an outside force to the predetermined section that is intended to shift inward, to induce further inward shifting thereof during a vacuum. In either event, it is preferable for the predetermined section of the battery can to have a readily inwardly shifted configuration.

With this production method for the secondary battery, when a vacuum is created and the predetermined section of the battery can is deformed, the center part of the electrode group is compressed, and air remaining in the interior can be driven out so that none remains. The predetermined section may be the center area of the top plate, the center area of the bottom plate of the outer case, or both. For example, the center area of the top plate is deformed, effectively compressing the center part of the electrode group during vacuum injection, and exhibiting the action of driving out air from the difficult-to-vent center interior. With this production method for the secondary battery, it is therefore possible to inject the electrolyte after air has been sufficiently vented from the interior of the electrode group, and the electrolyte can be made to reliably penetrate into the interior of the electrode group.

The vacuum injection step according to the present embodiment is provided with an injection step S5 in which a vacuum is created inside the battery can to deform a predetermined section of the can, and the electrolyte is injected; and a degassing step S7 in which, subsequent to the electrolyte having been injected, a vacuum is created a second time to deform the predetermined section, and gases in the interior of the electrode group are removed. Specifically, a first vacuum creation step and a second vacuum creation step are provided. Through such a configuration, air, gases, and the like in the electrode group interior can be effectively driven out via the first vacuum creation step (the injection step S5) and the second vacuum creation step (the degassing step S7), and the electrolyte can be made to reliably penetrate into the interior of the electrode group.

Specifically, the production method for the secondary battery, by virtue of a configuration whereby the electrolyte is injected after air, gases, and the like in the interior of the electrode group have been sufficiently vented, affords improved permeation of the electrolyte into the electrode group interior, and can induce the electrolyte to reliably penetrate into the interior of the electrode group.

Next, a working example and test results involving actual fabrication of lithium secondary batteries of predetermined structure, and checking of permeation of the electrolyte, are described.

### Examples

### (Fabrication of Positive Electrode Plates)

For the positive electrode active material, a slurry was prepared by mixing LiFePO₄ (90 weight parts), acetylene black (5 weight parts) as a conductive material, and polyvinylidene fluoride (5 weight parts) as binder, adding a suitable quantity of N-methyl-2-pyrrolidone as a solvent, and dispersing the materials. This slurry was applied evenly onto both faces of a positive collector of aluminum foil (20 μm in thickness), dried, then compressed with a roll press, and cut to predetermined size to fabricate positive electrode plates 2 of plate form.

The size of the fabricated positive electrode plates was 140 mm×250 mm, and the thickness was 230 μm. 32 of these positive electrode plates 2 were employed.

(Fabrication of Negative Electrode Plates)

For the negative electrode active material, a slurry was prepared by mixing natural graphite (90 weight parts), and polyvinylidene fluoride (10 weight parts) as binder, adding a suitable quantity of N-methyl-2-pyrrolidone as a solvent, and dispersing the materials. This slurry was applied evenly onto both faces of a negative collector of copper foil (16 μm in thickness), dried, then compressed with a roll press, and cut to predetermined size to fabricate negative electrode plates 3 of plate form.

The size of the fabricated negative electrode plates was 142 mm×255 mm, and the thickness was 146 μm. 33 of these negative electrode plates 3 were employed.

For the separators, 64 polyethylene films 145 mm×255 mm in size, and 25 μm in thickness, were fabricated.

(Fabrication of Nonaqueous Electrolyte)

LiPF₆ was dissolved at 1 mol/L into a mixed solution (solvent) of ethylene carbonate (EC) and diethyl carbonate (DEC) in a 30:70 ratio by volume, to prepare the nonaqueous electrolyte.

(Fabrication of Battery Can)

The materials for the outer case and the top plate constituting the battery can were respectively fabricated from nickel-plated iron plates. The standard dimensions thereof were a standard thickness of 1.0 mm; the size of the battery can was standardized to a size of 320 mm×150 mm×40 mm, respectively representing the inside dimensions for the lengthwise direction×widthwise direction×depth. The thickness of the top plate was varied between 1.0, 0.8, 0.6, 0.4, and 0.2 mm. Square lithium secondary batteries equipped with a recloseable injection port stopper were fabricated. The types of battery cans fabricated were: Type A employing a flat top plate, the entire top plate being uniformly thin; Type B in which both the flat top plate and the outer case bottom face are thin; Type C in which the top plate is stepped, with only the center part being thin; and Type D in which the top plate has a double structure which is thinner to the inside.

(Assembly of Secondary Battery)

The positive electrode plates and the negative electrode plate are stacked in alternating fashion via the separators. During this process, the 32 positive electrode plates, the 33 negative electrode plates, and the 64 separators are stacked such that the negative electrode plates are positioned to the outside of the positive electrode plates. The stack is then wrapped up with polyethylene film of the same 25 μm thickness as the separators, to construct an electrode group (stack).

As mentioned previously, the size of the separators intervening between the positive and negative electrode plates is 145 mm×255 mm, which is slightly larger than the size of the positive electrode plates (140×250) and the negative electrode plates (142×255). In so doing, the active material layers formed on the positive electrode plates and the negative electrode plates can be reliably covered. Connecting pieces of collector members (collector terminals) are then connected to the positive electrode exposed collector parts and the negative electrode exposed collector parts.

With the collector terminals connected, the electrode group is housed in the outer case, the collector members are connected to external terminals, the top plate is attached and sealed, and the nonaqueous electrolyte is injected under reduced pressure from the injection port via the vacuum injection step (the injection step and degassing step). After injection, the injection opening is sealed off. Five of each of the secondary batteries of the respective working examples were fabricated.

Example 1 is an example of a Type A secondary battery corresponding to the secondary battery RB1 of the first embodiment, and having top plate thickness of 0.8 mm Example 2 is an example of the same Type A, but with top plate thickness of 0.6 mm Example 3 is an example of the same Type A, but with top plate thickness of 0.4 mm Example 4 is an example of the same Type A, but with top plate thickness of 0.2 mm.

Example 5 is an example of a Type B in which both the flat top plate and the bottom plate of the outer case are thin, with the thickness of both the top plate and the bottom plate being 0.4 mm; the secondary battery corresponds to the secondary battery RB2 of the second embodiment.

Example 6 is an example of a Type C in which the top plate is stepped, with only the center part being thin, the center part being a stepped 100 mm×200 mm area 0.4 mm in thickness; and corresponds to the secondary battery RB3 of the third embodiment.

Example 7 is an example of a Type D in which the top plate has a double structure, with the outside top plate having standard 1.0 mm thickness, and the inside top plate having 0.4 mm thickness; and corresponds to the secondary battery RB4 of the fourth embodiment.

(Fabrication of Comparative Example)

As secondary batteries in a comparative example, secondary batteries employing a battery can of the same size and 1.0 mm thickness were fabricated, using an electrode group (stack) comparable to those used in the preceding working examples. As shown in FIG. 6 described previously, it was found that this thickness affords deformation (inward shifting) of 0.5 mm when injection is carried out at a −90 kPa vacuum.

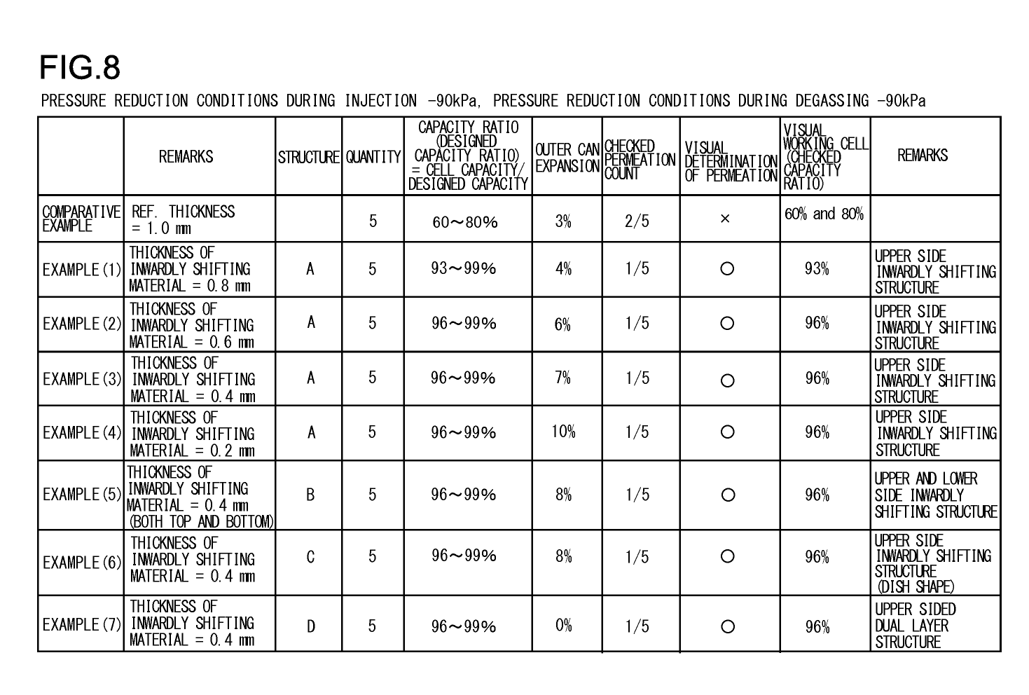

During fabrication of the respective secondary batteries, the degree of vacuum during injection and the degree of vacuum during degassing were both −90 kPa. Employing five of each of the secondary batteries of working examples 1 to 7, and five of those of the comparative example, the ratio of charging capacity to their respective designed capacity was checked. Samples for which the checked charging capacity ratio was found to be lower were disassembled, and the state of electrolyte penetration in the electrode group interior was visually checked. The rate of swelling of the battery can was measured after injection as well. These test results are described in FIG. 8.

As shown in FIG. 8, in the comparative example (plate thickness: 1.0 mm), the charging capacity ratio of the five samples ranged from 60 to 80%. When two samples with the 60% capacity ratio and two samples with the 80% ratio were respectively disassembled and the state of electrolyte penetration in the electrode group interior was visually checked, parts into which the electrolyte had not penetrated were observed, and the result of the visual determination was an “x.” Specifically, it was found that while the top plate of 1.0 mm thickness shifted inward by 0.5 mm in a −90 kPa vacuum, an amount of deformation of this extent cannot sufficiently vent residual air, gases, and the like in the electrode group interior.

In example 1, the charging capacity ratio ranged from 93 to 99%, and in example 2 from 96 to 99%. In examples 3 to 7 as well, the charging capacity ratio ranged from 96 to 99%. When the one sample observed to have the respectively lowest charging capacity ratio in each of the examples was disassembled and the state of electrolyte penetration in the electrode group interior was visually checked, the electrolyte could be checked to have uniformly penetrated, and all were found to be normal (the visual determination was an “∘.”) This may be understood to be entirely expected, given that the charging capacity ratio of each was 93% or more of the designed capacity. Specifically, the top plate with 0.8 mm thickness shifted inward by about 2.0 mm at −90 kPa, and it was found that deformation about equal this (inward shifting by a predetermined amount or more) can sufficiently vent residual air, gases, and the like in the electrode group interior.

These test results suggest that, in the case of a secondary battery of this size, it is preferable for a predetermined section of the battery can (for example, the center area) to an shift inward by 2.0 mm or more (about 5% or more, relative to the battery can thickness of 40 mm). Also, it was found that when the thickness of the outer case is 1.0 mm, by making the top plate thinner (0.8 mm or less), it is possible for the electrolyte to be injected into the stacked electrode group interior. In particular, it was found that it is even more effective for the thickness to be 0.6 mm or less, because the charging capacity ratio rises to 96 to 99%.

However, looking at the rate of expansion of the outer can (the battery can), in a case in which the thickness is 0.2 mm, expansion is 10%, and the change in dimensions is large enough to give rise to disadvantages in structure. Therefore, it is preferable to employ an outer can of appropriate thickness, according to the dimensional stability desired.

In particular, it was found that in an embodiment of the double structure top plate configuration of example 7, with only the inside top plate made thinner, a charging capacity ratio of 96 to 99% is obtained; and moreover the rate of expansion of the outer can is 0%, whereby results that are preferable both in terms of dimensional stability and capacity stability are obtained.

As described above, the secondary battery according to the present embodiment is configured such that deformation of the battery can taking place during internal pressure reduction or application of pressure from the outside (for example, when a vacuum is created) compresses the center part of the electrode group, and therefore during the injection step and the degassing step, a predetermined section of the battery can deforms by a predetermined amount or more, compressing the center part of the electrode group, and effectively driving out air, gases, and the like remaining in the interior. For this reason, notwithstanding the large size of the electrode group of several tens of stacked layers of positive electrode plates, negative electrode plates, and separators, the electrolyte can be induced to reliably penetrate into the interior of the electrode group.

Moreover, because the production method for a secondary battery according to the present embodiment involves bringing about deformation (inward shifting) of a predetermined section of the battery can by a predetermined amount or more during creation of a vacuum, to compress the center part of the electrode group, followed by injection, the electrolyte can be injected under conditions in which air, gases, and the like remaining in the electrode group interior have been sufficiently driven out. Therefore, notwithstanding the large size of the electrode group of several tens of stacked layers of positive electrode plates, negative electrode plates, and separators, the production method is one by which the electrolyte can be induced to reliably penetrate into the interior of the electrode group.

According to the present invention as described above, there are afforded a secondary battery and a method for producing same whereby, notwithstanding the large size of the electrode group of several tens of stacked layers of positive electrode plates, negative electrode plates, and separators, residual air, gases, or the like present between layers can be effectively driven out, and the electrolyte can be induced to reliably penetrate into the interior of the electrode group.

The secondary battery according to the present invention is favorably utilizable as a large-capacity storage battery of which large size and stable performance are desired.

What is claimed is:

1. A secondary battery comprising:
an electrode group of positive electrode plates and negative electrode plates stacked in a plurality of layers interposed by separators; an outer case for housing the electrode group; a top plate for sealing the outer case; and an electrolyte filling the interior of a battery can made of the outer case and the top plate;
wherein a predetermined section of the battery can opposing the vicinity of the center part of the electrode group is deformed by a predetermined amount or more due to being subjected to internal pressure reduction or to external pressure application, and a venting function for driving out residual air between layers is exhibited.

2. The secondary battery of claim 1, wherein
the predetermined section is the center part of the top plate; and the top plate is of a uniform thickness at which deformation is facilitated.

3. The secondary battery of claim 1, wherein
the top plate has a peripheral area of predetermined thickness at which can strength is exhibited, and a thinner, more readily deformable center area; and when the battery can is subjected to internal pressure reduction or to external pressure application, only the center area deforms, the peripheral area experiencing substantially no deformation.

4. The secondary battery of claim 3, wherein
the peripheral area and the center area are linked interposed by a step.

5. The secondary battery of claim 1, wherein
the top plate has a dual layer structure of an outside top plate of predetermined thickness at which can strength is exhibited, and a thinner, more readily deformable inside top plate; and
when the battery can is subjected to internal pressure reduction or to external pressure application, only the inside top plate deforms, the outside top plate experiencing substantially no deformation.

6. The secondary battery of claim 1, wherein
the battery can has a bottom plate that, when the battery can is subjected to internal pressure reduction or to external pressure application, experiences deformation in a section in proximity to the center part of the electrode group; and that, in cooperation with the top plate, exhibits a function of driving out and venting residual air between layers.

7. A method for producing a secondary battery, comprising:
a step in which an electrode group of positive electrode plates and negative electrode plates stacked in a plurality of layers interposed by separators is housed in an outer case; a step in which a top plate is attached to an opening of the outer case, sealing is achieved, and a battery can is made; and a vacuum injection step in which a vacuum is created in the interior of the sealed battery can, and an electrolyte is injected;
wherein
when a vacuum is created in the vacuum injection step, a predetermined section of the battery can opposing the vicinity of the center part of the electrode group is subjected to deformation by a predetermined amount or more, and a venting function for driving out residual air between layers is exhibited.

8. The production method for a secondary battery of claim 7, wherein
the predetermined section is a center area of the top plate, a center area of the bottom plate of the outer case, or both.

9. The production method for a secondary battery of claim 7, wherein
the vacuum injection step is provided with an injection step in which a vacuum is created inside the battery can, a predetermined section of the battery can is subjected to deformation,
and an electrolyte is injected; and a degassing step in which, after the electrolyte has been injected, a vacuum is created and the predetermined section subjected to deformation a second time, and the electrode group interior is degassed.
